(19) United States
(12) Patent Application Publication
(10) Pub. No.: US 2016/0220942 A1
(43) Pub. Date: Aug. 4, 2016

(54) FACILITY FOR PURIFYING HARMFUL GAS

(71) Applicant: Core Plasma Technology Inc., Williamsburg, VA (US)

(72) Inventor: Won Ju YI, Williamsburg, VA (US)

(73) Assignee: Core Plasma Technology Inc., Williamsburg, VA (US)

(21) Appl. No.: 14/994,159

(22) Filed: Jan. 13, 2016

(30) Foreign Application Priority Data
Feb. 2, 2015 (KR) 10-2015-0015996

(51) Int. Cl. B01D 53/00

(52) U.S. Cl. CPC B01D 53/007; B01D 2259/818; B01D 2259/806

(57) ABSTRACT

A facility for purifying harmful gas according to an exemplary embodiment of the inventive concept includes a vacuum pump for discharging harmful gas generated from the process chamber, preprocessing apparatus a preprocessing apparatus with which buffer gas for plasma discharge is provided together with the harmful gas discharged from the process chamber and performing preprocess such that noxious substances in the harmful gas and the buffer gas may be activated by emitting microwave, and a plasma reactor receiving the harmful gas including activated noxious substances and the activated buffer gas from the preprocessing apparatus and decomposing the activated substances by generating plasma discharge.

### CROSS-REFERENCE TO RELATED APPLICATIONS

This application claims priority under 35 U.S.C. §119 to Korean Patent Application No. 10-2015-0015996, filed on Feb. 02, 2015, in the Korean Intellectual Property Office, the entire contents of which are incorporated herein by reference.

### BACKGROUND

The present invention relates to a facility for purifying harmful gas, and more particularly, to a facility for removing harmful gas by decomposing noxious substances in the harmful gas generated during various processes.

Various raw materials are injected into a process chamber of low pressure, and processes such as ashing, evaporation, etching, photolithographic process, cleaning, nitration, and so on, are performed in the process of manufacturing semiconductors or displays. Harmful gas including noxious substances which are the restriction for the use of certain hazardous substances for environment including various volatile organic compounds, acids, odor generating gas, ignition material and non-CO₂ greenhouse gas is generated during the processes. Thus, the process chamber is required to be vacuum status to remove the harmful gas by a vacuum pump and to discharge the harmful gas into the air after purifying process.

FIG. 1 shows a conventional facility for disposing harmful gas, which includes a process chamber 10, a plasma reactor 30 below the process chamber 10 for removing noxious substances in harmful gas, and a vacuum pump 50 below the plasma reactor 30. The process chamber 10 and the plasma reactor 30 are connected by a pipe 20, so too the plasma reactor 30 and the vacuum pump 50.

The conventional plasma reactor 30 installed in such the facility for disposing harmful gas applies methods of radio frequency and inductively coupled plasma which may have low discharging stability, thereby requiring additional apparatuses for stabilizing discharging. The Korean patent registrations No. 10-1278682 and No. 10-1063515 disclosed a new plasma reactor to overcome the above problem of the conventional plasma reactor. The developed plasma reactor applies a method of Alternating Current (AC) discharge, thus, the use of electricity may be large, and the intensity of plasma in the center part of a conduit may be decreased due to large amount of harmful gas flow, which results in decline of decomposition performance of harmful gas. Due to the above problem, undecomposed noxious substances inside the harmful gas may flow through the vacuum pump, as a result, they cause malfunction of the vacuum pump when accumulated inside the vacuum pump or environment pollution when released to the air.

### DETAILED DESCRIPTION OF THE INVENTION

### Technical Problem of the Invention

The present invention provides a facility for purifying harmful gas for removing noxious substances or particles in the harmful gas generated during the semiconductor process, display process, etc. by decomposing the same.

### Technical Solution of the Invention

A facility for purifying harmful gas according to an exemplary embodiment of inventive concept includes a vacuum pump discharging harmful gas generated in a process chamber, a preprocessing apparatus which is provided with buffer gas for plasma discharge together with the harmful gas discharged from the process chamber and performing preprocess for activation of noxious substances in the harmful gas and the buffer gas by irradiating microwave, and a plasma reactor which is provided with harmful gas including the activated noxious substances and activated buffer gas from the preprocessing apparatus and decomposes the activated noxious substances by generating plasma discharge.

A facility for purifying harmful gas according to another exemplary embodiment of inventive concept includes a vacuum pump discharging harmful gas generated in the process chamber, a plasma reactor installed between the process chamber and the vacuum pump for decomposing noxious substances in the harmful gas discharged from the process chamber with plasma, and a preprocessing apparatus preprocessing the harmful gas such that noxious substances in the harmful gas may be activated by irradiating microwave to the harmful gas discharged from the process chamber.

### EFFECTS OF THE INVENTION

A facility for purifying harmful gas according to embodiments of the present invention applies microwave by irradiating the same to harmful gas in a preprocessing apparatus before decomposing the harmful gas in a plasma reactor.

Accordingly, noxious substances in the harmful gas become activated to have increased kinetic energy during the above process such that the noxious substances may be decomposed and removed well by plasma discharge in the plasma reactor, which is increase in decomposition performance.

Especially, buffer gas provided by the preprocessing apparatus may contribute to the activation of noxious substances to maintain the increased decomposition performance in the plasma reactor, in case that vitalizing noxious substances is not successful or the degree of activation is weak only with the microwave.

A facility for purifying harmful gas according to embodiments of the present invention may prevent damages on a conduit in the plasma reactor caused by decomposition of noxious substances, because the activated noxious substances is decomposed and removed by plasma discharge of low energy generated in the plasma reactor.

### BRIEF DESCRIPTION OF THE DRAWINGS

Exemplary embodiments of the inventive concept will be more clearly understood from the following detailed description taken in conjunction with the accompanying drawings in which:

FIG. 1 is a schematic view of a conventional facility for purifying harmful gas;

FIG. 2 is a schematic view of a facility for purifying harmful gas according to an exemplary embodiment of the present inventive concept;

FIGS. 3 and 4 are cross-sectional views showing exemplary embodiments of a preprocessing apparatus in the facility for purifying harmful gas of FIG. 2;

FIG. 5 is a cross-sectional view of a plasma reactor in the facility for purifying harmful gas of FIG. 3.

FIG. 6 is a schematic view of a facility for purifying harmful gas according to another exemplary embodiment of the present inventive concept; and

FIG. 7 is a cross-sectional view of a preprocessing apparatus in the facility for purifying harmful gas of FIG. 6.

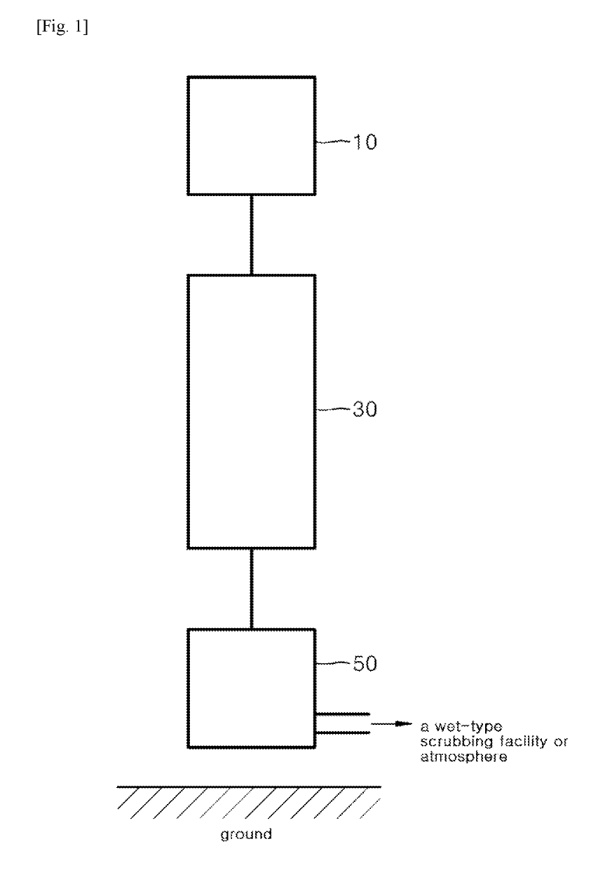

### BEST MODE FOR CARRYING OUT THE INVENTION

Various example embodiments will be described more fully hereinafter with reference to the accompanying drawings, in which some example embodiments are shown. Inventive concepts may, however, be embodied in many different forms and should not be construed as limited to the example embodiments set forth herein. Rather, example embodiments are provided so that this disclosure will be thorough and complete, and will fully convey the scope of inventive concepts to those skilled in the art. In the drawings, the sizes and relative sizes of layers and areas may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the inventive concepts. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacently” versus “directly adjacently,” etc.).

The terminology used herein is for the purpose of describing particular example embodiments only and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

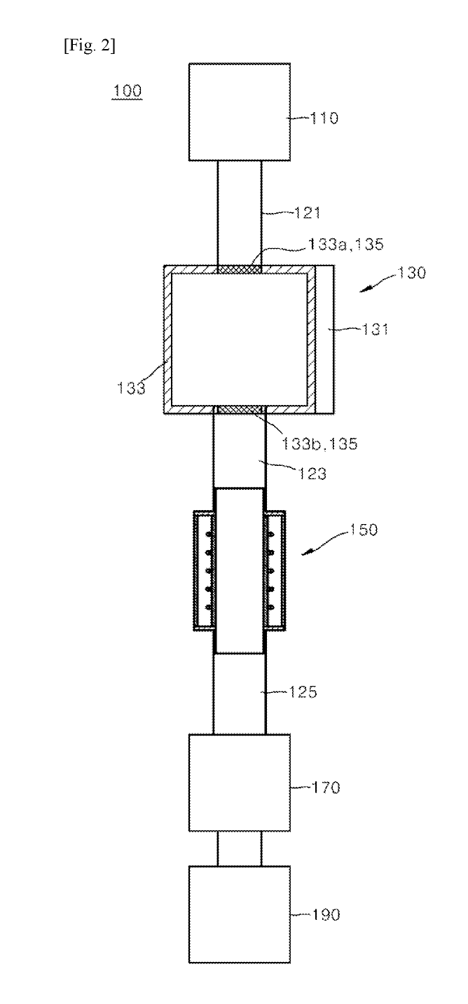

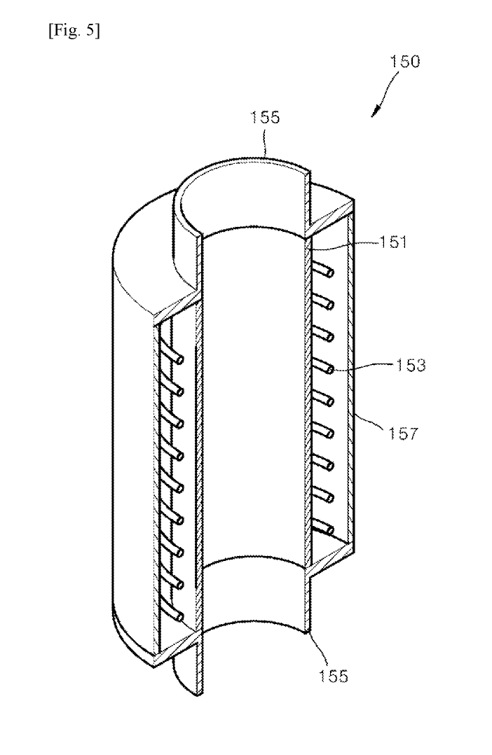

FIGS. 2 through 7 show a facility for purifying harmful gas according to exemplary embodiments of the inventive concept. First of all, the facility for purifying harmful gas according to an exemplary embodiment of the inventive concept is described referring to FIGS. 2 through 5.

Referring to FIG. 2, the facility for purifying harmful gas according to an exemplary embodiment of the inventive concept includes a process chamber 110, a preprocessing apparatus 130, a plasma reactor 150, a vacuum pump 170, and a scrubber 190. The process chamber 110 is a chamber in which various operations of semiconductor or display process such as ashing, evaporation, etching, photolithography, cleaning, nitration, and so on, are performed.

The exemplary embodiment takes the example of etching for the process in the process chamber 110. Various kinds of process gas and buffer gas are provided during the etching process, and the process gas used for the etching process generates noxious by-products such as CF₄ and NF₃. The vacuum pump 170 makes the insides of the process chamber 110, pipes 121, 123, 125 which will be described later, the preprocessing apparatus 130, and the plasma reactor 150, to be vacuum state of lower pressure than the air pressure and performs discharging remaining harmful gas from the process chamber 110 after the etching process.

Meanwhile, the vacuum pump 170 includes an exhaust pipe (not shown) at the latter end such that the harmful gas may be discharged to the air through the exhaust pipe. Or the scrubber 190 may be further installed as shown in FIG. 2. For example, the scrubber 190 may be a wet scrubbing apparatus.

The harmful gas generated during the etching process in the process chamber 110 includes unreacted material and by-products during the process as noxious substances. Thus, the plasma reactor 150 is installed between the process chamber 110 and the vacuum pump 170 to remove the noxious substances in the harmful gas, and the preprocessing apparatus 130 is installed between the process chamber 110 and the plasma reactor 150 to boost decomposing noxious substances in the harmful gas in the plasma reactor so as the noxious substances to be removed.

More specifically, the preprocessing apparatus 130 is installed between a first pipe 121 in which the harmful gas discharged from the process chamber 110 flows and a second pipe 123 in which the harmful gas preprocessed in the preprocessing apparatus 130 flows to the plasma reactor 150. The preprocessing apparatus 130 emits microwave to the harmful gas flows to the first pipe 121 from the process chamber 110 so as noxious substances in the harmful gas to be activated.

The preprocessing apparatus 130 includes a microwave generator 131 and a microwave reflection chamber 133. The microwave generator 131 includes a magnetron (not shown) and a wave guide (not shown). The microwave generator 131 generates the microwave and provides the same to the microwave reflection chamber 133.

The microwave reflection chamber 133 includes interior space reflecting the microwave. The microwave reflection chamber 133 includes an inlet 133a and an outlet 133b each connected to the first pipe 121 and the second pipe 123. Once the harmful gas is input through the inlet 133a, the microwave generated from the microwave generator 131 is emitted to the harmful gas such that noxious substances in the harmful gas may be activated and then be discharged through the outlet 133b.

The microwave reflection chamber 133 may be various structures such as a rectangular parallelepiped, cylinder, and so on. The exemplary embodiment takes the example of a rectangular parallelepiped structure. The one side of the microwave reflection chamber 133 includes the inlet 133a connected to the first pipe 121, and the opposite side of the microwave reflection chamber 133 includes the outlet 133b connected to the second pipe 122.

The microwave reflection chamber 133 includes interior space with a structure reflecting the microwave provided by the microwave generator 131. That is, the interior space of the microwave reflection chamber 133 is formed of a conductive material and is sealed in the remaining parts except the inlet 133a and the outlet 133b.

The microwave provided by the microwave generator 131 may not leak to the outside and be reflected only in the microwave reflection chamber 133 infinitely, because the interior space is made of a conductive material and sealed. But, the microwave loses its energy by collision with substances and then dissipates itself, and the microwave in this embodiment collides with noxious substances in the harmful gas to lose its energy and then dissipates itself.

That is, the noxious substances are activated with increased kinetic energy by absorbing energy from the microwave. At this time, the temperature inside the microwave reflection chamber 133 is confirmed to be increased. Kinetic energy of an object is proportional to the temperature, accordingly, the temperature increases when the noxious substances have increased kinetic energy by absorbing energy from the microwave, resulting the temperature increase in the interior space of the microwave reflection chamber 133. Thus, the activation of the noxious substances in the harmful gas may be confirmed by measuring temperature inside the microwave reflection chamber 133 with a temperature sensor.

Meanwhile, although not shown in the drawings, buffer gas may be further provided into the microwave reflection chamber 133 along with the harmful gas. The buffer gas may be one of H₂O, gas, or liquid. The noxious substances in the harmful gas are so various that activation only by the microwave may not be successful. Accordingly, the buffer gas provided into the microwave reflection chamber 133 is activated by the microwave and then flows to the plasma reactor 150 along with the harmful gas, as a result, the buffer gas decomposes the noxious substances in the harmful gas together with the plasma discharge because the buffer gas in the state of being activated may be dissociated by the plasma discharge sooner than the harmful gas. Like this, the decomposition function for noxious substances in the harmful gas may be increased with the assistance of buffer gas.

As described above, the microwave reflection chamber 133 includes the inlet 133a and the outlet 133b. At this time, the microwave may leak through the inlet 133a and the outlet 133b if the inlet 133 and the outlet 133b are maintained to be open. Accordingly, mesh 135 is prepared on the inlet 133a and the outlet 133b, respectively, to avoid the above.

The mesh 135 includes plurality of holes (not shown) through which only the harmful gas may be input or discharged, but not the microwave. The microwave may be reflected.

The microwave may not pass through the hole smaller than a fourth of its wavelength size. Thus, the microwave may not pass through the mesh 135 and may be reflected continuously within the microwave reflection chamber 133, when the size of each hole of the plurality of holes on the mesh 135 is formed to be smaller than a fourth of the microwave wavelength.

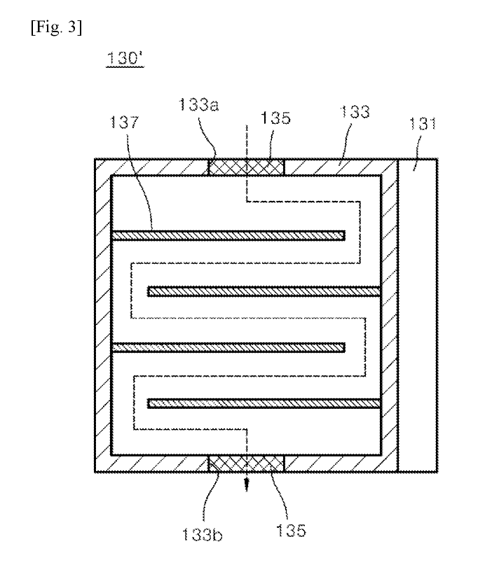

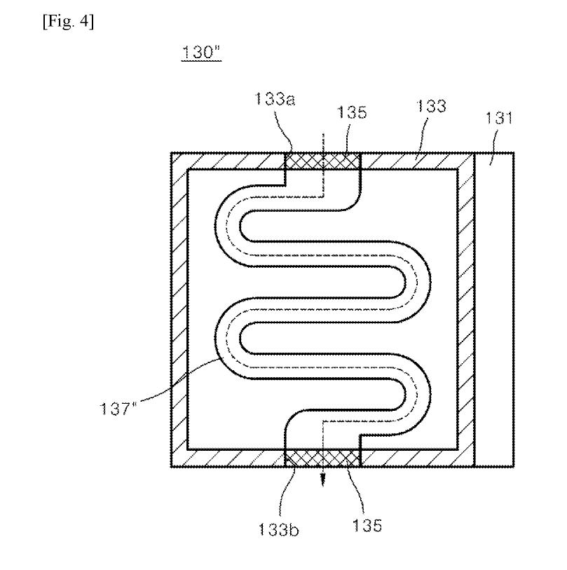

FIGS. 3 and 4 show different exemplary embodiments of the above preprocessing apparatus. The identical compositions with the preprocessing apparatus 130 in the preprocessing apparatus in FIGS. 3 and 4 are referred to as the same drawing reference numbers, and descriptions of those will be omitted.

Referring to FIG. 3, a preprocessing apparatus 130′ according to another exemplary embodiment of the inventive concept includes a plurality of baffles 137 inside the microwave reflection chamber 133. The baffles 137 are arranged to face each other while being separated by the predetermined space in alternation with each other. The harmful gas input to the microwave reflection chamber 133 flows through the path set by the baffles 137 while changing the flow direction by the plural times.

The baffle 137 may be formed of a material through which the microwave may pass or reflecting the microwave. The baffles 137 installed inside the microwave reflection chamber 133 block the straight flow path of the harmful gas to the outlet 133b while altering the flow direction by the plural times, accordingly, the harmful gas may stay longer inside the microwave reflection chamber 133 such that more noxious substances in the harmful gas may be activated.

Referring to FIG. 4, a preprocessing apparatus 130″ according to yet another exemplary embodiment of the inventive concept includes a duct 137″ inside the microwave reflection chamber 133. The duct 137′' connects connects the inlet 133a and the outlet 133b and forms a flow path of the harmful gas input through the inlet 133a.

The duct 137″ is bended by the plural times with forms of “S” and alters the flow direction of the harmful gas by the plural times like the baffles 137 in the above embodiment. But, the harmful gas flows inside the duct 137″, accordingly, the duct 137″ is required to be made of a material transmitting the microwave.

The harmful gas flowing through the duct 137″ stays long inside the microwave reflection chamber 133 while flowing inside the microwave reflection chamber 133 from the inlet 133a and to the outlet 133b due to the structure of the duct 137″ altering the flow direction by the plural times. More amount of the noxious substances may be activated by the microwave in the duct 137″ of the microwave reflection chamber 133 while staying long as the duct 137″ is made of a material transmitting the microwave.

After the noxious substances in the harmful gas are activated by the apparatus for preprocessing the harmful gas 130, 130′, 130″, the harmful gas is discharged through the outlet 133b and input to the plasma reactor 150 through the second pipe 123. The plasma reactor 150 decomposes noxious substances in the preprocessed harmful gas undergone the preprocess in the preprocessing apparatus 130 with reaction to the plasma discharge.

The plasma reactor 150 uses a radio frequency (RF) source for an energy source. The plasma reactor 150 includes a conduit 151, a coil unit 153 winding the outer surface of the conduit 151 in a spiral, flanges 155, and an outer pipe 157. The conduit 151 is a flow path of the harmful gas, which has a cylinder form with a longitudinal through hole. The conduit 151 is made of high-k dielectric such as alumina, zirconia (ZrO₂), yttria (Y₂O₃), sapphire, quartz, glass, or the like. Especially, using mixed powder of alumina and yttria with pressed and coating the alumina tube with sputtering resistant yttria spraying may increase etch resistant feature. The conduit 151 and the coil unit 153 winding the same are protected by the outer pipe 157. That is, the plasma reactor 150 is formed of a double pipe by arranging the conduit 151 and the coil unit 153 inside the outer layer pipe 157. The double pipe form prevents electromagnetic waves generated by the coil unit 153 from releasing to the outside of the plasma reactor 150.

The double pipe form also prevents gas leakage in the plasma reactor 150 caused by cracks or damage on the conduit 151. The conduit 151 may have cracks and damage by itself during the plasma discharge in a vacuum status of high temperature, accordingly, the connection of the conduit 151 to the surrounding pipe may have cracks.

The coil unit 153 decomposes noxious substances in the harmful gas flowing inside the conduit 151 by generating RF plasma discharge from the coil unit 153 with appliance of electricity from outside. The conduit 151 is made of dielectrics so as to be protected from damage caused by RF plasma discharge generated from the coil unit 153 and protect the coil unit 153.

The flanges 155 are located at both ends of the conduit 151 and connect the conduit 151, the second pipe 123, and the third pipe 125. The flanges 155 are also made of dielectrics like the conduit 151 such that the second pipe 123 and the third pipe 125 may be protected from damage caused by RF plasma discharge generated from the coil unit 153. Meanwhile, although the plasma discharge is generated by the RF power source in the plasma reactor 150 in the exemplary embodiments of the inventive concept, the embodiments are not restricted thereto, and plasma discharge may be generated by an AC power source, a DC power source, and microwave.

The plasma reactor 150 decomposes noxious substances in the harmful gas flowing inside the conduit 151 with the plasma discharge generated from the coil unit 153. Especially, the harmful gas undergone the substance activation through the preprocessing apparatus 130 is input to the plasma reactor 150, accordingly, the reaction of the noxious substances to the plasma discharge improves. Thus, more noxious substances in the harmful gas are decomposed and removed than decomposing through only in the plasma reactor 150 with reaction to the plasma discharge, thereby enhancing the purifying performance with regards to the harmful gas.

The purified gas undergone the decomposition of noxious substances by the plasma reactor 150 flows to the vacuum pump 170 and the scrubber 190 to be discharged to the outside. The vacuum pump 170 and the scrubber 190 may not be damaged because the gas is purified, and the purified gas discharged to the outside may not cause air pollution.

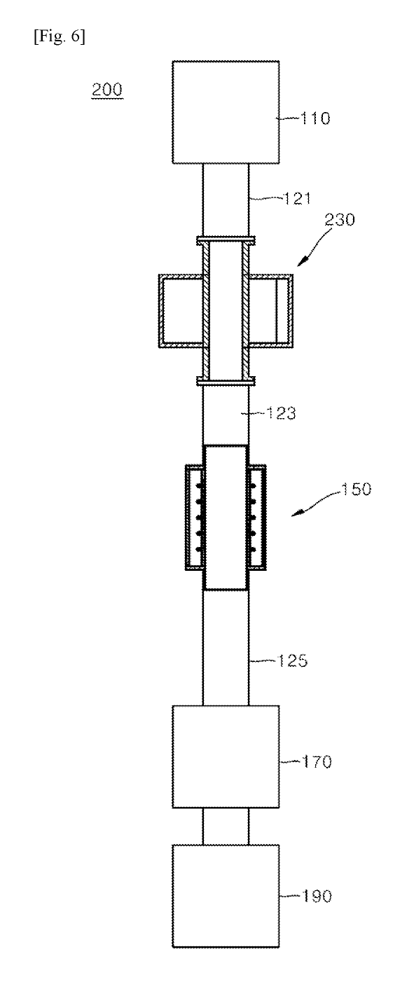

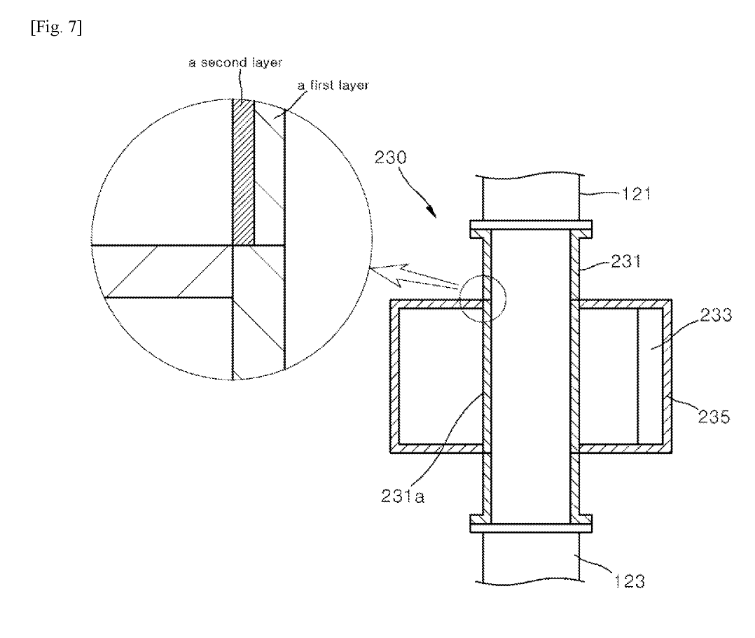

FIGS. 6 and 7 show a facility for purifying harmful gas 200 according to another exemplary embodiment of the inventive concept. The facility for purifying harmful gas 200 is different from the facility for purifying harmful gas 100 only in a preprocessing apparatus 230. Thus, just the preprocessing apparatus 230 will be described hereinafter.

The preprocessing apparatus 230 includes a microwave transmitting pipe 231, a magnetron 233, and a housing 235. The microwave transmitting pipe 231 is installed between the first pipe 121 in which the harmful gas discharged from the process chamber 110 flows and the second pipe 123 in which the preprocessed harmful gas flows to the plasma reactor 150 with mutually communicated. The microwave transmitting pipe 231 has a through hole for inputting and outputting the harmful gas and is formed of a material transmitting the microwave at least by a portion.

The microwave transmitting pipe 231 includes a region surrounded by the housing 235 which is formed of one-layered material transmitting the microwave, and the rest region that is consisted of a first layer of anti-corrosion material and a second layer of conductive material reflecting the microwave.

The rest region is formed of multi-layers including the first layer and the second layer, which is for blocking loss of the microwave that a portion of the microwave escapes to the outside. The first layer also helps to prevent the second layer from being damaged by the microwave. But, embodiments may not be restricted thereto, and the rest region may be formed of one layered conductive material that can reflect the microwave.

Meanwhile, the microwave transmitting pipe 231 is made of a material transmitting the microwave, such as quartz material, ceramic material, plastic material, and carbon material. Also, the anti-corrosion material is at least one of quartz material, ceramic material, plastic material, and carbon material.

The magnetron 233 generates the microwave and provides the same into the inside of the microwave transmitting pipe 231. The magnetron 233 is installed between the microwave transmitting pipe 231 and the housing 235, wherein the housing 235 is formed of a material reflecting the microwave. The housing 235 encloses the microwave transmitting pipe 231 so as to have space from the outer circumference surface of the microwave transmitting pipe 231, and the magnetron 233 is prepared in the space. Although not shown in the drawings, a waveguide (not shown) may be further prepared inside the space. The size of the waveguide may be set by the wavelength of the microwave.

The microwave generated from the magnetron 233 passes through the microwave transmitting pipe 233 and collides with noxious substances in the harmful gas floating inside the microwave transmitting pipe 233. At this time, the microwave energy is absorbed into the noxious substances, which results in increase of kinetic energy of the noxious substances and activation thereof. Meanwhile, the microwave which may not collide with the noxious substances passes through the microwave transmitting pipe 231 to arrive at the housing 235 and may be reflected by the housing 235 again.

Meshes (not shown) may be installed at one side of the microwave transmitting pipe 233, the side of inflow of the harmful gas discharged from the process chamber 110, the other side of the microwave transmitting pipe 233, and the side of discharge of the harmful gas including activated noxious substances. The meshes are used to prevent damage to the plasma reactor 150 and to the microwave itself by blocking the microwave from transmitting toward the process chamber 110 or the plasma reactor 150 while allowing free inlet and outlet of the harmful gas.

Meanwhile, although not shown in the drawings, the preprocessing apparatus 230 may be connected to the plasma reactor 150 directly. That is, the side of discharging the harmful gas from the preprocessing apparatus 230 is directly connected to the plasma reactor 150. In case that the preprocessing apparatus 230 and the plasma reactor 150 are connected directly, time for the harmful gas flowing to the plasma reactor 150 may be shortened, thereby increasing treatment efficiency of the activated harmful gas.

While the present invention has been particularly shown and described with reference to exemplary embodiments thereof, it will be understood that various changes in form and details may be made therein without departing from the spirit and scope of the following claims.

What is claimed is:

1. A facility for purifying harmful gas comprising:
a vacuum pump discharging harmful gas generated in a process chamber;
a preprocessing apparatus with which buffer gas for plasma discharge is provided along with the harmful gas discharged from the process chamber and preprocessing noxious substances in the harmful gas and the buffer gas so as to be activated by emitting microwave; and
a plasma reactor to which the harmful gas including the activated noxious substances and the activated buffer gas flow from the preprocessing apparatus and which decomposes the activated noxious substances by generating plasma discharge.

2. The facility for purifying harmful gas of claim 1, wherein the preprocessing apparatus comprising:
a microwave generator generating microwave; and
a microwave reflection chamber having a structure of reflecting microwave inside and discharging the harmful gas to an outlet after vitalizing noxious substances contained therein by emitting microwave provided from the microwave generator.

3. The facility for purifying harmful gas of claim 2, wherein the microwave reflection chamber has a sealed structure with conductive material except for the inlet and the outlet.

4. The facility for purifying harmful gas of claim 2, wherein baffles are installed inside the microwave reflection chamber such that the harmful gas may be altered in the flow direction by the plural times by the baffles and then discharged through the outlet.

5. The facility for purifying harmful gas of claim 2, wherein the microwave reflection chamber includes a duct connecting to the inlet and the outlet with a through hole by each end and which is made of a material transmitting the microwave.

6. The facility for purifying harmful gas of claim 1, wherein the preprocessing apparatus comprising:
a microwave transmitting pipe which is installed between the process chamber and the plasma reactor with mutually communicated to pass the harmful gas from the inlet to the outlet and made of a material transmitting the microwave by at least a part;
a housing formed so as to surround the outer circumference surface of the microwave transmitting pipe and is configured to reflect the microwave by the inside; and
a magnetron installed between the microwave transmitting pipe and the housing and generating the microwave.

7. The facility for purifying harmful gas of claim 6,
wherein the microwave transmitting pipe is formed of a material transmitting the microwave only by the region surrounded by the housing; and
wherein the housing is formed of a conductive material reflecting the microwave.

8. The facility for purifying harmful gas of claim 6, wherein the rest region except for the region surrounded by the housing in the microwave transmitting pipe comprising:
a first layer formed of an anti-corrosion material; and
a second layer surrounding the first layer and formed of a conductive material reflecting the microwave, wherein the anti-corrosion material includes at least one of quartz material, ceramic material, plastic material, and carbon material.

9. The facility for purifying harmful gas of claim 1, wherein the plasma reactor comprising:
a conduit with a through hole in which the harmful gas undergone the preprocess by the preprocessing apparatus flows; and
a coil unit winding the outer circumference surface of the conduit and generating plasma discharge when applied with a power source.

10. The facility for purifying harmful gas of claim 9, wherein the plasma reactor further includes an outer pipe forming space from the outer circumference surface and surrounding the conduit so as to protect the conduit and the coil unit.

11. A facility for purifying harmful gas comprising:
a vacuum pump discharging harmful gas generated from a process chamber;
a plasma reactor installed between the process chamber and the vacuum pump and decomposing noxious substances in the harmful gas by plasma; and
a preprocessing apparatus installed between the process chamber and the plasma reactor and preprocessing the harmful gas such that noxious substances in the harmful gas may be activated by emitting microwave to the harmful gas discharged from the process chamber.

12. The facility for purifying harmful gas of claim 11, wherein the preprocessing apparatus comprising:
a microwave generator generating microwave; and
a microwave reflection chamber having an internal structure of reflecting microwave and vitalizing noxious substances in the harmful gas input through the inlet by emitting microwave generated from the microwave generator, and then discharging the harmful gas through the outlet.

13. The facility for purifying harmful gas of claim 12, wherein the microwave reflection chamber includes a sealed structure of a conductive material in the rest region except for the inlet and the outlet.

14. The facility for purifying harmful gas of claim 12, wherein the microwave reflection chamber includes baffles by which the flow direction of the harmful gas input to the inlet is altered by the plural times, and then the harmful gas is discharged through the outlet.

15. The facility for purifying harmful gas of claim 12, wherein the inside of the microwave reflection chamber includes a duct connected to the inlet and the outlet by each end and is formed of a material transmitting the microwave.

16. The facility for purifying harmful gas of claim 11, wherein the preprocessing apparatus comprising:
a microwave transmitting pipe installed between the process chamber and the plasma reactor with mutually communicated, including a through hole such that the harmful gas may be input to and discharged from, and being formed of a material transmitting the microwave by at least a part;
a housing formed so as to surround the outer circumference surface of the microwave transmitting pipe and configured to reflect the microwave by the inside; and
a magnetron installed between the microwave transmitting pipe and the housing and generating the microwave.

17. The facility for purifying harmful gas of claim 16, wherein the microwave transmitting pipe is made of a material transmitting the microwave only by the region surrounded by the microwave generator, and
wherein the housing is made of a conductive material reflecting the microwave.

18. The facility for purifying harmful gas of claim 16, wherein the rest region except for the region surrounded by the microwave generator comprising:
a first layer made of an anti-corrosion material; and
a second layer surrounding the first layer and made of a conductive material reflecting the microwave, wherein the anti-corrosion material includes at least one of the quartz material, ceramic material, plastic material, and carbon material.

19. The facility for purifying harmful gas of claim 1, wherein the plasma reactor comprising:
a conduit including a through hole for inputting and the outputting the harmful gas undergone preprocess by the preprocessing apparatus; and
a coil unit surrounding the outer circumference surface of the conduit and generating plasma discharge when a power supply is applied.

20. The facility for purifying harmful gas of claim 19, the plasma reactor further includes an outer pipe forming space from the outer circumference surface and surrounding the conduit so that the conduit and the coil unit are protected.
